(19) United States
(12) Patent Application Publication
(10) Pub. No.: US 2018/0323590 A1
(43) Pub. Date: Nov. 8, 2018

(54) Electrical Conduit with Alignment Marks

(71) Applicant: Loren P. Cassidy, LaVista, NE (US)

(72) Inventor: Loren P. Cassidy, LaVista, NE (US)

(21) Appl. No.: 15/968,245

(22) Filed: May 1, 2018

Related U.S. Application Data
(60) Provisional application No. 62/530,710, filed on Jul. 10, 2017.
(60) Provisional application No. 62/500,935, filed on May 3, 2017.

(51) Int. Cl. H02G 3/04

(52) U.S. Cl. CPC H02G 3/0406; H02G 3/0481

(57) ABSTRACT

A bendable electrical conduit includes a body fabricated from a ductile material. The body includes an exterior surface, a channel defined by an interior surface, and a wall of a select thickness separating the exterior surface and the interior surface. The body includes at least two alignment marks disposed on the exterior surface. A set of alignment marks of the at least two alignment marks are separated by a selected angle. The at least two alignment marks includes at least one line. The body is configured to be insertable within a bending tool. The body is configured to plastically deform following an application of a force to the exterior surface of the body via the bending tool. Plastic deformation of the body generates one or more bends along the length of the body.

### CROSS-REFERENCE TO RELATED APPLICATIONS

The present application claims the benefit under 35 U.S.C. § 119(e) of U.S. Provisional Patent Application Ser. No. 62/500,935, filed May 3, 2017, titled NO-DOG ELECTRICAL CONDUIT, naming Loren P. Cassidy as inventor, which is incorporated herein by reference in the entirety; and U.S. Provisional Patent Application Ser. No. 62/530,710, filed Jul. 10, 2017, titled NO-DOG ELECTRICAL CONDUIT, naming Loren P. Cassidy as inventor, which is incorporated herein by reference in the entirety.

### TECHNICAL FIELD

The present invention generally relates to electrical raceway systems and, more particularly, to electrical conduit with alignment marks.

### BACKGROUND

Electrical conduit is a raceway system often used when installing residential, commercial, and industrial wiring. Electrical conduit provides a means to distribute power and control wiring, and additionally provides a high level of protection for the contained wiring from physical damage.

Shaping the electrical conduit for a particular application often requires precision bends (e.g. offset bends, saddle bends, kick or rise bends, or the like), of which there exist numerous combinations. These specific bends may require precision alignments on equal and opposite sides of the electrical conduit. In addition, shaping the electrical conduit requires either manually-operated or mechanically-operated bending tools to create the desired bends. Accuracy with these bending tools requires time and skill, and a correct bend is often not generated on the first attempt. Further, shaping the electrical conduit may require special tools (e.g., offset levels and torpedo levels) to guide the shaping of the electrical conduit. The special tools, however, may be difficult to set and adjust, and may lack the precision necessary to correctly shape the electrical conduit into the desired design.

A pipe not in perfect alignment while creating the desired bends results in a skewed electrical conduit bend, or a dogleg. A skewed or misshapen electrical conduit is often not noticed until an operator attempts to install the electrical conduit, requiring the operator to remove and re-shape the electrical conduit or discard the skewed or misshapen electrical conduit entirely.

Therefore, it would be advantageous to provide a system and method that cures the shortcomings described above.

### SUMMARY

A bendable electrical conduit is disclosed, in accordance with one or more embodiments of the present disclosure. In one embodiment, the bendable electrical conduit includes a body fabricated from a ductile material. In another embodiment, the body includes an exterior surface. In another embodiment, the body includes a channel defined by an interior surface. In another embodiment, the body includes a wall of a select thickness separating the exterior surface and the interior surface. In another embodiment, the body includes four alignment marks disposed on the exterior surface. In another embodiment, each set of adjacent alignment marks of the four alignment marks are separated by ninety degrees. In another embodiment, each alignment mark of the four alignment marks includes at least one solid line. In another embodiment, the body is configured to be insertable within a bending tool. In another embodiment, the body is configured to plastically deform following an application of a force to the exterior surface of the body via the bending tool. In another embodiment, plastic deformation of the body generates one or more bends along the length of the body.

A bendable electrical conduit is disclosed, in accordance with one or more embodiments of the present disclosure. In one embodiment, the bendable electrical conduit includes a body fabricated from a ductile material. In another embodiment, the body includes an exterior surface. In another embodiment, the body includes a channel defined by an interior surface. In another embodiment, the body includes a wall of a select thickness separating the exterior surface and the interior surface. In another embodiment, the body includes at least two alignment marks disposed on the exterior surface. In another embodiment, a set of alignment marks of the at least two alignment marks are separated by a selected angle. In another embodiment, the at least two alignment marks includes at least one line. In another embodiment, the body is configured to be insertable within a bending tool. In another embodiment, the body is configured to plastically deform following an application of a force to the exterior surface of the body via the bending tool. In another embodiment, plastic deformation of the body generates one or more bends along the length of the body.

A method is disclosed, in accordance with one or more embodiments of the present disclosure. In one embodiment, the method includes, but is not limited to, inserting a bendable electrical conduit into a bending tool including a bending shoe. In another embodiment, the bendable electrical conduit includes a body fabricated from a ductile material. In another embodiment, the body includes an exterior surface. In another embodiment, the body includes a channel defined by an interior surface. In another embodiment, the body includes a wall of a select thickness separating the exterior surface and the interior surface. In another embodiment, the body includes at least two alignment marks disposed on the exterior surface. In another embodiment, a set of alignment marks of the at least two alignment marks are separated by a selected angle. In another embodiment, the at least two alignment marks includes at least one line. In another embodiment, the body is configured to plastically deform following an application of a force to the exterior surface of the body via the bending tool. In another embodiment, plastic deformation of the body generates one or more bends along the length of the body. In another embodiment, the method includes, but is not limited to, bending the bendable electrical conduit via the bending tool until an alignment mark of the at least two alignment marks aligns with a sight line on the bending shoe of the bending tool.

### BRIEF DESCRIPTION OF THE DRAWINGS

The numerous advantages of the present disclosure may be better understood by those skilled in the art by reference to the accompanying figures in which:

FIG. 1A illustrates a perspective view of electrical conduit with alignment marks, in accordance with one or more embodiments of the present disclosure;

FIG. 1B illustrates a front view of electrical conduit with alignment marks, in accordance with one or more embodiments of the present disclosure;

FIG. 1C illustrates a perspective view of electrical conduit with alignment marks, in accordance with one or more embodiments of the present disclosure;

FIG. 1D illustrates a perspective view of electrical conduit with alignment marks, in accordance with one or more embodiments of the present disclosure;

FIG. 2A illustrates a perspective view of electrical conduit with alignment marks, in accordance with one or more embodiments of the present disclosure;

FIG. 2B illustrates a front view of electrical conduit with alignment marks, in accordance with one or more embodiments of the present disclosure;

FIG. 3 illustrates a perspective view of electrical conduit with alignment marks, in accordance with one or more embodiments of the present disclosure;

FIG. 4 illustrates a perspective view of electrical conduit with alignment marks, in accordance with one or more embodiments of the present disclosure;

FIG. 5A illustrates a process for bending electrical conduit with alignment marks via a bending shoe, in accordance with one or more embodiments of the present disclosure;

FIG. 5B illustrates a process for bending electrical conduit with alignment marks via a bending shoe, in accordance with one or more embodiments of the present disclosure;

FIG. 5C illustrates a process for bending electrical conduit with alignment marks via a bending shoe, in accordance with one or more embodiments of the present disclosure;

FIG. 6A illustrates a process for bending electrical conduit with alignment marks via a bending shoe, in accordance with one or more embodiments of the present disclosure;

FIG. 6B illustrates a process for bending electrical conduit with alignment marks via a bending shoe, in accordance with one or more embodiments of the present disclosure;

FIG. 6C illustrates a process for bending electrical conduit with alignment marks via a bending shoe, in accordance with one or more embodiments of the present disclosure;

FIG. 6D illustrates a process for bending electrical conduit with alignment marks via a bending shoe, in accordance with one or more embodiments of the present disclosure;

FIG. 6E illustrates a process for bending electrical conduit with alignment marks via a bending shoe, in accordance with one or more embodiments of the present disclosure;

FIG. 6F illustrates a process for bending electrical conduit with alignment marks via a bending shoe, in accordance with one or more embodiments of the present disclosure;

FIG. 7A illustrates a process for fabricating electrical conduit with alignment marks, in accordance with one or more embodiments of the present disclosure; and

FIG. 7B illustrates a process for fabricating electrical conduit with alignment marks, in accordance with one or more embodiments of the present disclosure.

### DETAILED DESCRIPTION OF THE INVENTION

Reference will now be made in detail to the subject matter disclosed, which is illustrated in the accompanying drawings.

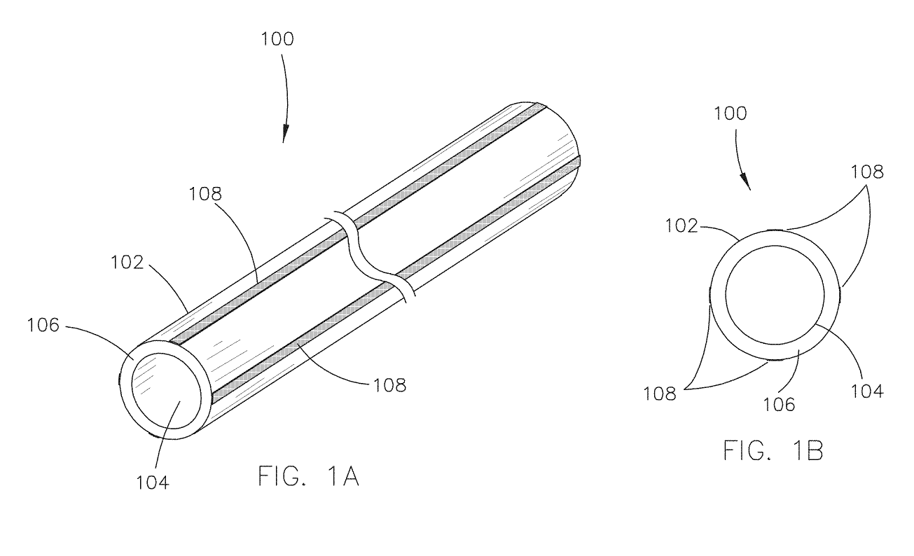

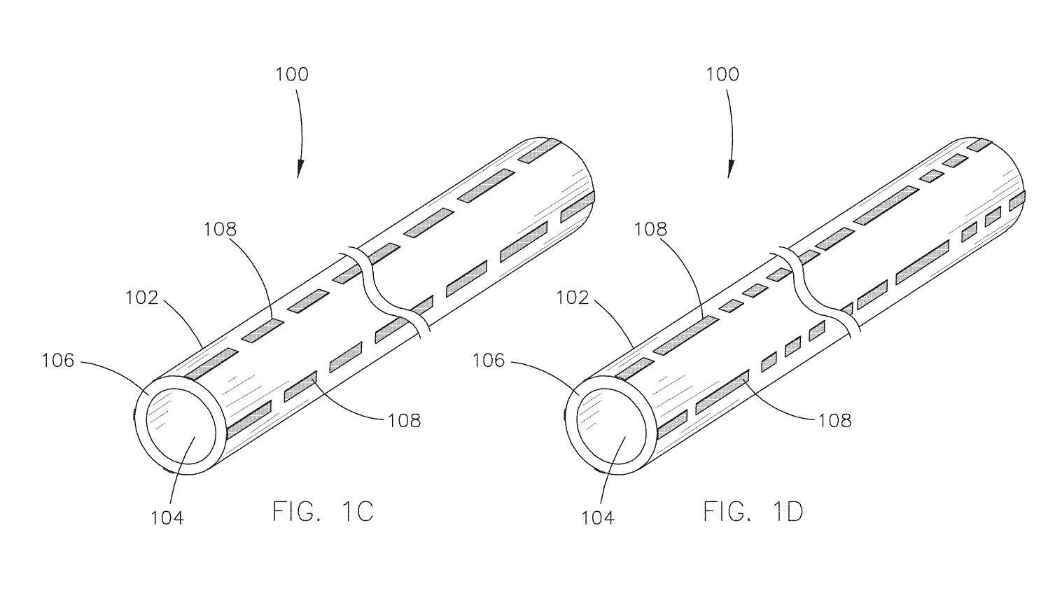

FIGS. 1A-7B generally illustrate electrical conduit with alignment marks, in accordance with one or more embodiments of the present disclosure.

Embodiments of the present disclosure are directed to electrical conduit with one or more alignment marks. Embodiments of the present disclosure are also directed to bending the electrical conduit with a bending tool without the need for a second operator or special alignment tools. Embodiments of the present disclosure are also directed to utilizing the one or more alignment marks when bending the electrical conduit via the bending tool to prevent skewed and/or misshapen electrical conduit bends, or doglegs.

Referring generally to FIGS. 1A-4, electrical conduit 100 is illustrated, in accordance with one or more embodiments of the present disclosure.

In one embodiment, the electrical conduit 100 includes a body. In another embodiment, the body includes an exterior surface 102. In another embodiment, the body includes an inner channel or cavity defined by an interior surface 104. In another embodiment, the body includes a wall 106 of a select thickness separating the exterior surface 102 and the interior surface 104.

The body of the electrical conduit 100 may include any cross section known in the art. For example, the body may include, but is not limited to, a circular or a substantially circular cross section. By way of another example, the body may include, but is not limited to, a non-circular cross section (e.g. rectangular, square, elliptic, or the like).

The electrical conduit 100 may be any type of electrical conduit known in the art. For example, the electrical conduit 100 may include, but is not limited to, metal conduit such as rigid metal conduit (RMC), intermediate metal conduit (IMC), electrical metallic tubing (EMT), flexible metallic conduit or liquid-tight flexible metal electrical conduit (LFMC), or the like. By way of another example, the electrical conduit 100 may include, but is not limited to, non-metal conduit such as liquid-tight flexible nonmetallic conduit (LNFC), poly vinyl chloride (PVC) tubing, or the like. More generally, the electrical conduit may be any type of rigid electrical conduit or flexible electrical conduit known in the art.

The electrical conduit 100 may be fabricated from any type of ductile material known in the art. For example, the electrical conduit 100 may be fabricated from a material including, but not limited to, steel, galvanized steel, stainless steel, iron, galvanized iron, zinc, aluminum, brass, plastic, fiber, or the like. In this regard, the electrical conduit 100 is configured to plastically/permanently deform (or undergo plastic/permanent deformation) and retain one or more bends generated following the application of a force via a bending tool (e.g., bending tool 500, as illustrated throughout the present disclosure).

It is noted herein the electrical conduit 100 may be opaque, substantially opaque, or translucent depending on the type of material from which the electrical conduit 100 is fabricated.

The electrical conduit 100 may include any type of coating known in the art. For example, the electrical conduit 100 may include a coating on the exterior surface 102. By way of another example, the electrical conduit 100 may include a coating on the interior surface 104. By way of another example, the electrical conduit 100 may include, but is not limited to, a metal coating (e.g., zinc coating, or the like), an organic coating, a metal/organic hybrid coating, a plastic coating, a waterproof coating, a water-resistant coating, a flame-resistant coating, a flame-retardant coating, a corrosion-proof coating, a corrosion-resistant coating, or the like.

The electrical conduit 100 may include any trade size known in the art. For example, the trade size may include, but is not limited to, ½, ¾, 1, 1¼, 1½, 2, 2½, 3, 3½, 4, 5, 6, or the like. The electrical conduit 100 may include any length known in the art. For example, the electrical conduit 100 may range from 5 feet to 25 feet in length. For example, the electrical conduit 100 may be 5, 10, or 20 feet in length. The exterior surface 102 may include any outer diameter known in the art. For example, the electrical conduit 100 may include an outer diameter ranging from 0.25 inches to 7 inches. The interior surface 104 may include any inner diameter known in the art. For example, the electrical conduit 100 may include an inner diameter ranging from 0.25 inches to 7 inches.

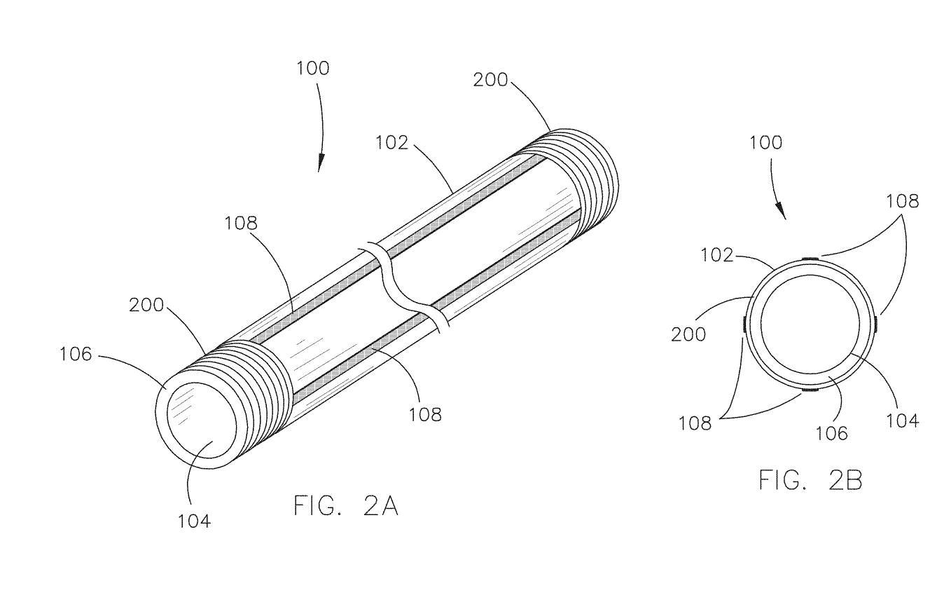

The electrical conduit 100 may be threaded or unthreaded. FIGS. 1A-1D illustrate unthreaded electrical conduit 100, while FIGS. 2A and 2B illustrate one or more threaded sections 200 on a portion of the exterior surface 102 of the electrical conduit 100. The electrical conduit 100 may include any type of threading known in the art. For example, the threading may include, but is not limited to, ½, ¾, 1, 1¼, 1½, 2, or the like.

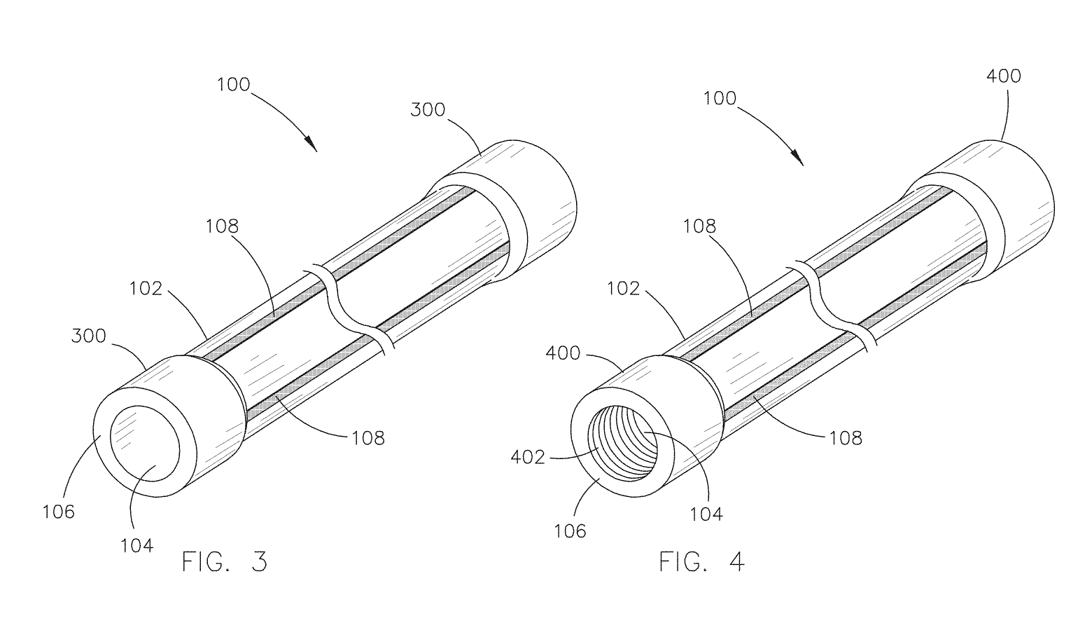

The electrical conduit 100 may include a coupler. FIG. 3 illustrates a smooth-bore coupler 300, while FIG. 4 illustrates a coupler 400 with internal threading 402. It is noted herein the coupler may be an integrated component of the electrical conduit 100, formed during the fabrication of the electrical conduit 100. In addition, it is noted herein the coupler may be a separate component coupled to the electrical conduit 100 via one or more fasteners (e.g., set screws), an adhesive, or the like. Further, it is noted herein the coupler may include one or more components (e.g., fasteners including set screws, or the like) to couple to electrical conduit 100 inserted into the coupler.

In one embodiment, the electrical conduit 100 includes one or more alignment marks 108. For example, the one or more alignment marks 108 may be disposed on the exterior surface 102 of the electrical conduit 100. By way of another example, where the electrical conduit 100 is translucent, the one or more alignment marks 108 may be disposed on the interior surface 104 of the electrical conduit 100 and/or embedded within the wall 106 of the electrical conduit 100.

In another embodiment, the one or more alignment marks 108 are disposed along a selected length of the electrical conduit 100. For example, the one or more alignment marks 108 may be disposed along the entire length of the electrical conduit 100, extending parallel with the long central axis of the electrical conduit 100. By way of another example, the one or more alignment marks 108 may be disposed on a portion of the electrical conduit 100.

For instance, the one or more alignment marks 108 may be disposed on a portion of unthreaded electrical conduit 100. In addition, the one or more threaded sections 200 are disposed on a first portion of the exterior surface 102, while the one or more alignment marks 108 may be disposed on an additional portion of the exterior surface 102 different from the first portion. However, it is noted herein the one or more alignment marks 108 may extend onto the one or more threaded sections 200. Further, the one or more couplers 300, 400 are an integrated component or coupled to a first portion of the exterior surface 102, respectively, while the one or more alignment marks 108 may be disposed on an additional portion of the exterior surface 102 different from the first portion. However, it is noted herein the one or more alignment marks 108 may extend onto the couplers 300, 400.

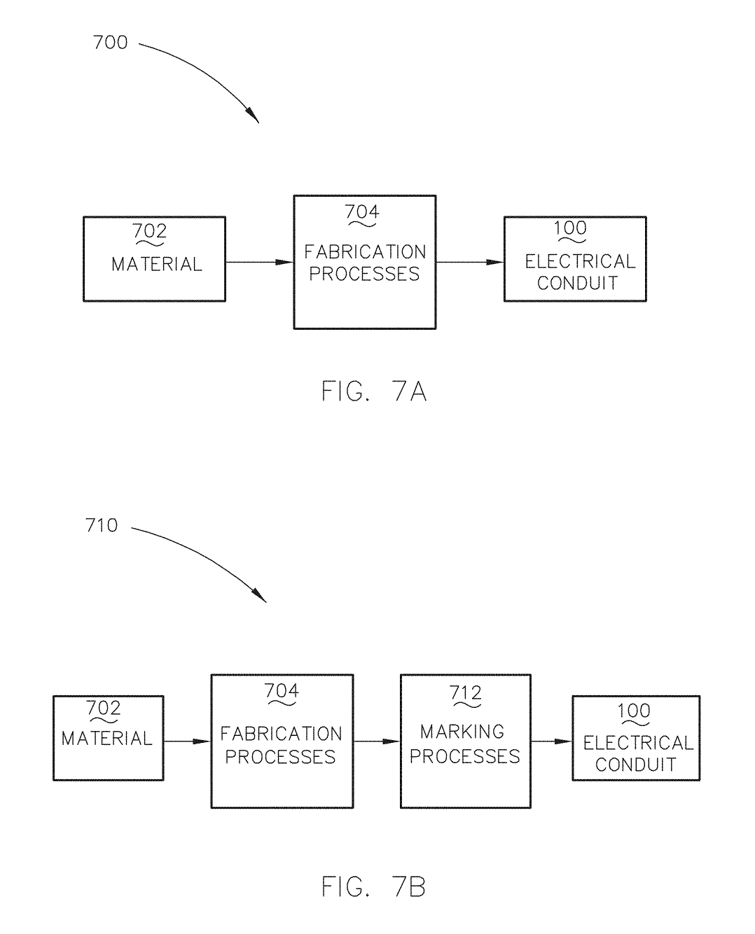

In another embodiment, the one or more alignment marks 108 are permanently disposed on the electrical conduit 100, allowing an operator to bend the electrical conduit 100 without concern of the one or more alignment marks shifting and/or being altered. For example, the one or more alignment marks 108 may be scored, etched, extruded, formed, casted, molded, stamped, printed, or any other fabrication process or marking process known in the art. For instance, as illustrated in FIG. 7A, the one or more alignment marks 108 may be generated during the fabrication of the electrical conduit 100 from material 702 via one or more fabrication processes 704, where the one or more fabrication processes 704 are performed by one or more tools including, but not limited to, a scorer, an etcher, an extruder, a roller, one or more dies, a forming apparatus, a casting apparatus, a molding press, a stamp press, or the like. In addition, as illustrated in FIG. 7B, the one or more alignment marks 108 may be generated following the fabrication of the electrical conduit 100 from the material 702 via one or more marking processes 712, the one or more marking processes 712 performed by one or more tools including, but not limited to, a video jet printer including an ink jet printing system or a laser jet printing system, a spray paint marking system, a brush paint marking system, or the like.

In another embodiment, the one or more fabrication processes 704 and the one or more marking processes 712 are simultaneous or substantially simultaneous processes. In another embodiment, the one or more marking processes 712 are subsequent processes to the one or more fabrication processes 704.

Although embodiments of the present disclosure are directed to the one or more alignment marks 108 being permanently disposed on the surface of the electrical conduit 100, it is noted herein the one or more alignment marks 108 may be temporarily disposed on the electrical conduit 100. For example, the one or more alignment marks 108 may include a sticker. By way of another example, the one or more alignment marks may include a metal or plastic plate applied via an adhesive, one or more fasteners, one or more tack welds, or the like. Therefore, the above description should not be interpreted as a limitation on the present disclosure but merely an illustration.

In another embodiment, the one or more alignment marks 108 include one or more lines. For example, the one or more alignment marks 108 may include one line. By way of another example, the one or more alignment marks 108 may include two or more lines. For example, the two or more lines may be parallel or substantially parallel. For instance, the two or more lines may be aligned along a central axis. In addition, the two or more lines may be side-by-side.

In another embodiment, as illustrated in FIGS. 1A, 2A, 3, and 4, the one or more alignment marks 108 include one or more unbroken and/or solid lines. In another embodiment, the one or more alignment marks 108 include one or more broken and/or not solid lines. For example, as illustrated in FIG. 1C, the one or more alignment marks 108 may include one or more patterned lines. For instance, the one or more patterned lines may include, but is not limited to, a dash pattern, a dot pattern, a pattern including a combination of dashes and dots, a pattern including one or more shapes in a repeating combination, or the like. By way of another example, as illustrated in FIG. 1D, the one or more alignment marks 108 may include one or more un-patterned lines. More generally, the one or more broken and/or not solid lines may include, but are not limited to, any type of mark, icon, shape, or known in the art.

By way of another example, the one or more alignment marks 108 may include one or more lines of text. It is noted herein the text forming a portion of the two or more sections of the one or more alignment marks 108 may include, but is not limited to, information about the electrical conduit 100 including dimensions, material, or date of fabrication; information about the process used to fabricate the electrical conduit 100; fabricator name or location, or logo; bar codes; standards logos; information about wiring passed through the electrical conduit 100; industry-standard or product-specific warnings; or the like. More generally, text may be disposed on any portion of the exterior surface 102, including as a part of the one or more alignment marks 108 or separate from the one or more alignment marks 108.

In addition, it is noted herein the one or more alignment marks 108 may be color-coded based on trade size and/or grading of the electrical conduit 100, and/or color-coded based on gage of electrical wires running through the electrical conduit 100.

Further, it is noted herein the one or more alignment marks 108 may be intersected by one or more cross-hatch marks, where the one or more cross-hatch marks are set a selected distance apart on the electrical conduit 100. For example, the one or more cross-hatch marks may be set apart a selected distance ranging from 0.25 inches to 5 inches. For instance, the selected distance may be 1 inch. It is noted herein that the one or more cross-hatch marks may be perpendicular to the one or more alignment marks 108 and/or the long central axis of the electrical conduit 100, for purposes of the present disclosure.

Further, it is noted herein the one or more patterned alignment marks 108 as illustrated in FIG. 1C and/or the one or more un-patterned alignment marks 108 as illustrated in FIG. 1D may be applied to the exterior surface 102 of the electrical conduit 100 as illustrated in FIGS. 2A, 3, and/or 4. Therefore, the above description should not be interpreted as a limitation on the present disclosure but merely an illustration.

Although embodiments of the present disclosure are directed to disposed the one or more alignment marks 108 on the electrical conduit 100, it is noted herein the one or more alignment marks 108 may be disposed on any component known in the art that couples to electrical conduit 100. For example, the one or more alignment marks 108 may be disposed on adapters, connectors, bushings, grommets, grounding clamps, clips, fittings, reducing washers, locknuts, nuts, access ports/conduit bodies, or electrical boxes (e.g., outlet boxes, switch boxes, or the like). Therefore, the above description should not be interpreted as a limitation on the present disclosure but merely an illustration.

In another embodiment, the one or more alignment marks 108 are evenly-spaced on a surface (e.g., exterior surface 102 or interior surface 104) of the electrical conduit 100. For example, the one or more alignment marks 108 may be evenly-spaced on the surface of the electrical conduit 100 for any angle, ranging from 1 degree to 359 degrees. Select examples of the angle spacing are illustrated in Table 1.

TABLE 1

| Number of | Spacing Angle on |
|---|---|
| Alignment Marks 108 | Electrical Conduit 100 (degrees) |
| 2 | 180 |
| 3 | 120 |
| 4 | 90 |
| 6 | 60 |
| 8 | 45 |
| 12 | 30 |
| 16 | 22.5 |
| 36 | 10 |

In one example, where the electrical conduit 100 includes four alignment marks 108, the four alignment marks 108 may be disposed on the electrical conduit 100 based on a spacing angle of 90 degrees from a relative 0-degree starting point, as illustrated in Table 1. For instance, the four alignment marks 108 may be located at 0 degrees, 90 degrees, 180 degrees, and 270 degrees on the electrical conduit 100. In addition, the four alignment marks 108 may be located at 30 degrees, at 120 degrees, at 210 degrees, and at 300 degrees on the electrical conduit 100.

In another example, where the electrical conduit 100 includes eight alignment marks 108, the eight alignment marks 108 may be disposed on the electrical conduit 100 based on a spacing angle of 45 degrees from a relative 0-degree starting point, as illustrated in Table 1. For instance, the eight alignment marks may be provided at 0 degrees, at 45 degrees, at 90 degrees, at 135 degrees, at 180 degrees, at 225 degrees, at 270 degrees, and at 315 degrees on the electrical conduit 100. In addition, the eight alignment marks may be provided at 15 degrees, at 60 degrees, at 105 degrees, at 150 degrees, at 195 degrees, at 240 degrees, at 285 degrees, and at 330 degrees on the electrical conduit 100.

In another embodiment, the one or more alignment marks 108 are not evenly-spaced around the circumference of the electrical conduit 100. For example, where the electrical conduit 100 includes three alignment marks 108, the three alignment marks 108 may be disposed on the electrical conduit 100 based on a spacing angle of 90 degrees from a relative 0-degree starting point (e.g., at 0 degrees, 90 degrees, and 180 degrees), instead of being disposed on the electrical conduit 100 based on a spacing angle of 120 degrees as illustrated in Table 1. By way of another example, where the electrical conduit 100 includes six alignment marks 108, the six alignment marks 108 may be disposed on the electrical conduit 100 based on a spacing angle of 45 degrees from a relative 0-degree starting point (e.g., at 0 degrees, 45 degrees, 90 degrees, 180 degrees, 225 degrees, and at 270 degrees), instead of being disposed on the electrical conduit 100 based on a spacing angle of 60 degrees as illustrated in Table 1. In this regard, the one or more alignment marks 108 on the electrical conduit 100 may be specifically designed for a particular intended use.

As illustrated in FIGS. 1A, 1C, 1D, 2A, 3, and 4, the electrical conduit 100 is shown with a symbolic break in its length, where the symbolic break indicates no particular length or diameter of the electrical conduit 100. It is noted herein that material that may be visible between the symbolic break has been removed for the sake of clarity. In addition, it is noted herein the appearance of any portion of the electrical conduit 100 between the symbolic break may not be considered an integral or required component of the electrical conduit 100. Further, the electrical conduit 100 is not limited to the scale as illustrated herein.

As illustrated in FIGS. 1A-4, the one or more alignment marks 108 are shown raised and/or protruded from the exterior surface 102. While it is understood that the disposed one or more alignment marks 108 will inherently have a raised and/or protruded thickness relative to the exterior surface 102, it is noted herein the emphasized nature of the raised and/or protruded thickness of the one or more alignment marks 108 relative to the exterior surface 102 is included for the sake of clarity. In addition, it is noted herein the raising and/or protruding of the one or more alignment marks 108 relative to the exterior surface 102 may not be considered and integral or required component of the electrical conduit 100.

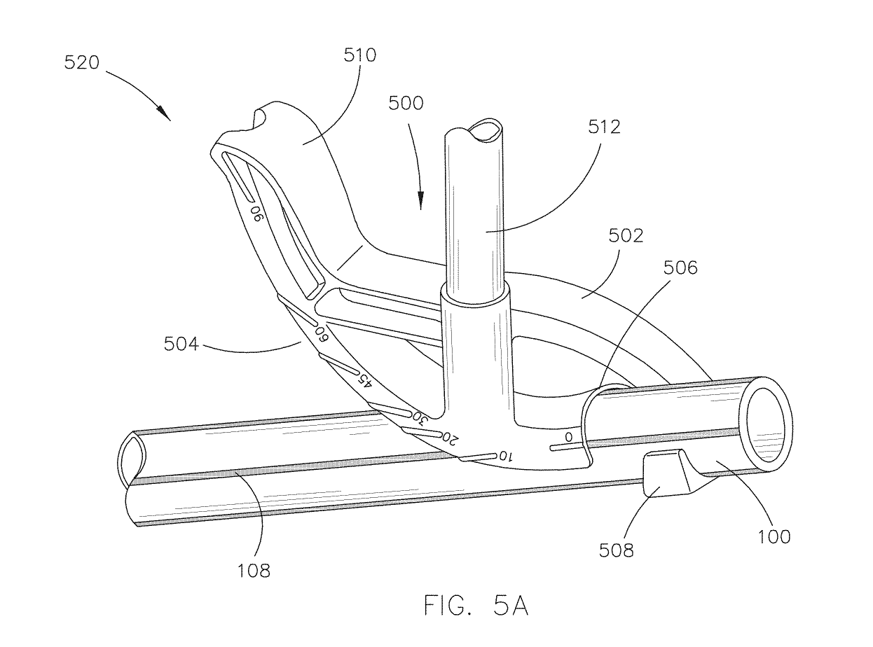

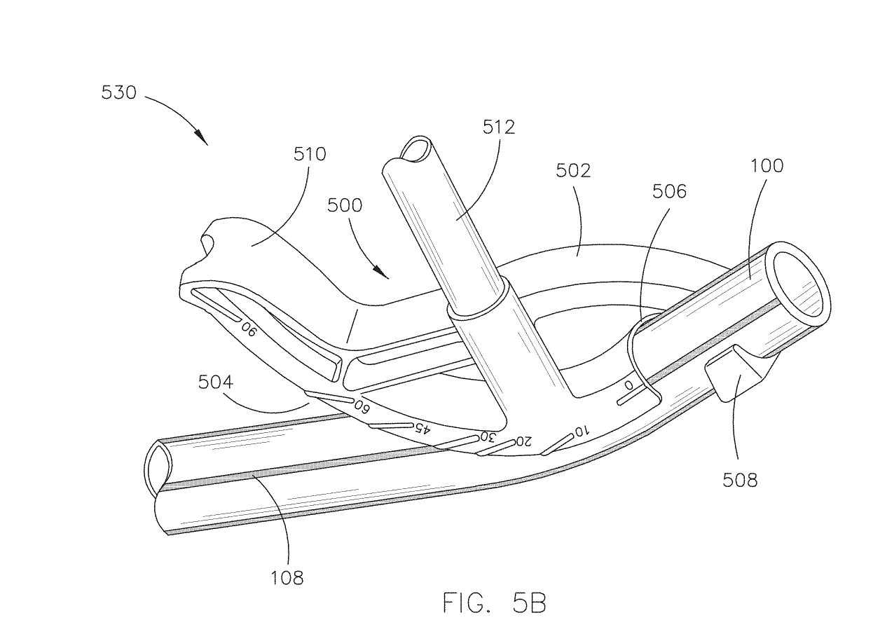

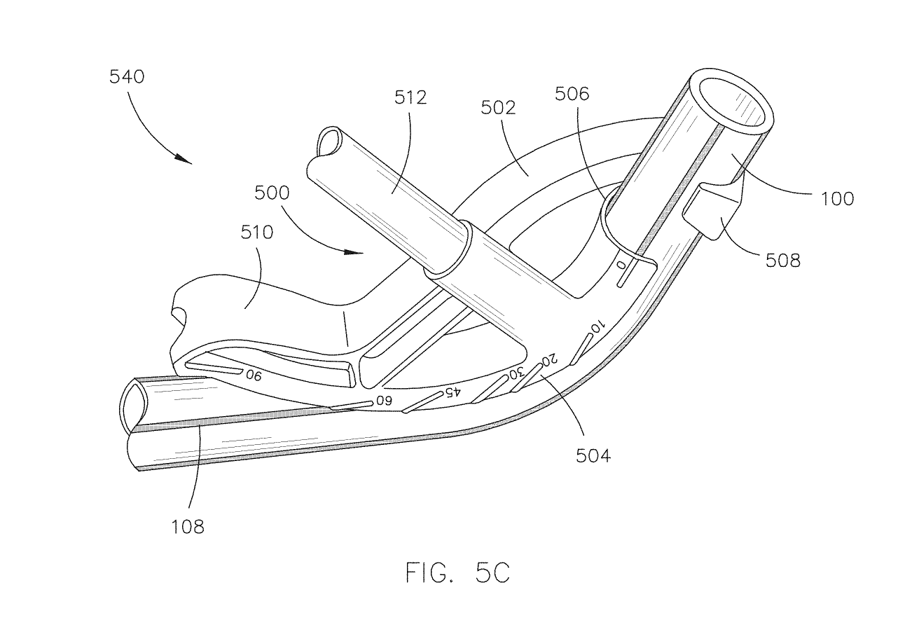

Referring now to FIGS. 5A-5C, processes to bend electrical conduit 100 via a bending tool 500 is illustrated, in accordance with one or more embodiments of the present disclosure.

In one embodiment, the bending tool 500 includes a bending shoe 502. In another embodiment, the bending shoe 502 includes one or more notches or sight lines 504 representing a set of angles along a rim of a conduit bend channel 506. For example, the one or more sight lines 504 may be representing a set of angles including, but not limited to, 0 degrees, 10 degrees, 22.5 degrees, 30 degrees, 45 degrees, 60 degrees, 90 degrees, or the like.

In another embodiment, the bending shoe 500 includes a hook 508 proximate to an end of the conduit beam channel 506. For example, the hook 508 is configured to receive the electrical conduit 100 and prevent the electrical conduit 100 from leaving the conduit bend channel 506 during a bending process. In another embodiment, the one or more alignment marks 108 are visible when the electrical conduit 100 is inserted into the bending shoe 502, as the electrical conduit 100 extends beyond the conduit bend channel 506 and the hook 508.

In another embodiment, the bending shoe 500 includes a foot pedal 510 configured to provide an operator increased leverage and/or support when applying a force to the electrical conduit 100. In another embodiment, the bending tool 500 includes a handle 512 coupled to the bending shoe 500, where the handle 512 is configured to provide an operator increased leverage and/or support when applying a force to the electrical conduit 100, or the like. For example, the handle 512 may include, but is not limited to, a smooth grip, a textured or non-slip grip, one or more protrusions, or the like.

In another embodiment, a center mark is etched, molded, and/or otherwise marked on the bending shoe 502 in place of a 0-degree sight line 504. For example, the one or more alignment marks 108 may align with the center mark on the bending shoe 502. It is noted herein that if the bending shoe 502 does not include a center mark or a 0-degree sight line 504, the operator may add a center mark to the bending shoe 502 that aligns with the one or more alignment marks 108.

The electrical conduit 100 may shift in the bending shoe 502 when force is applied by an operator. This shift may be enough to require re-alignment of the electrical conduit 100 within the bending shoe 502, often multiple times before a desired alignment is achieved. In addition, it is noted herein that accurately aligning a second bend following a first bend may require manually-sighting down a pre-determined length of the electrical conduit 100 towards the first bend. Further, it is noted herein that if the electrical conduit 100 rotates any amount other than the desired amount of rotation while the pipe is being shaped, the operator may have to take additional time to re-sight and re-bend the electrical conduit 100 and/or employ a second operator to adjust the alignment of the electrical conduit 100 as the first operator maintains the applied force on the bending shoe 502.

With the one or more alignments marks 108, however, re-alignment may not require a second operator at the lead end of the electrical conduit 100 passed through the bending shoe 502, as illustrated via the set of processes in FIGS. 5A-5C to form a bend in the electrical conduit 100 including four evenly-spaced alignment marks 108. It is noted herein the set of processes in FIGS. 5A-5C are not limited to the processes provided. For example, the set of processes in FIGS. 5A-5C may instead include more or fewer processes. By way of another example, the set of processes in FIGS. 5A-5C may perform the processes in an order other than provided. Therefore, the above description should not be interpreted as a limitation on the scope of the present disclosure, but merely an illustration.

In a process 520, as illustrated in FIG. 5A, the electrical conduit 100 is inserted into the conduit bend channel 506 and the hook 508 at a first distance along the length of the electrical conduit 100. Without leaving the control area of the bending tool 500, the operator may align an alignment mark 108 with a sight line 504 (e.g., the 0-degree sight line 504) of the bending shoe 502.

In a process 530, as illustrated in FIG. 5B, the electrical conduit 100 is bent to an angle of 30 degrees, where the alignment mark 108 aligns with the 30-degree sight line 504, via a force exerted on the bending tool 500 (e.g., exerted on the handle 512, the foot pedal 510 of the bending shoe 502, or the like) by the operator.

In a process 540, as illustrated in FIG. 5C, the electrical conduit 100 is bent to an angle of 60 degrees, where the alignment mark 108 aligns with the 60-degree sight line 504, via a force exerted on the bending tool 500 (e.g., exerted on the handle 512, the foot pedal 510 of the bending shoe 502, or the like) by the operator.

It is noted herein the force exerted to bend the electrical conduit from 0 degrees to 60 degrees may be continuous and/or be intermittent without concern of the electrical conduit 100 slipping within the bending shoe 500, as the operator may rely on the comparison between the alignment mark 108 and the sight lines 502 to re-align the electrical conduit 100 should it slip. In this regard, the one or more alignment marks 108 may reduce the need for an additional operator to act as a spotter to notice any shifting of the electrical conduit 100 during a bending process and/or notice the when the correct angle is formed in the electrical conduit 100. In addition, the one or more alignment marks 108 may reduce the need for an operator to leave the control area of the bending tool 500 when checking the alignment of the electrical conduit 100 within the bending shoe 502 of the bending tool 500.

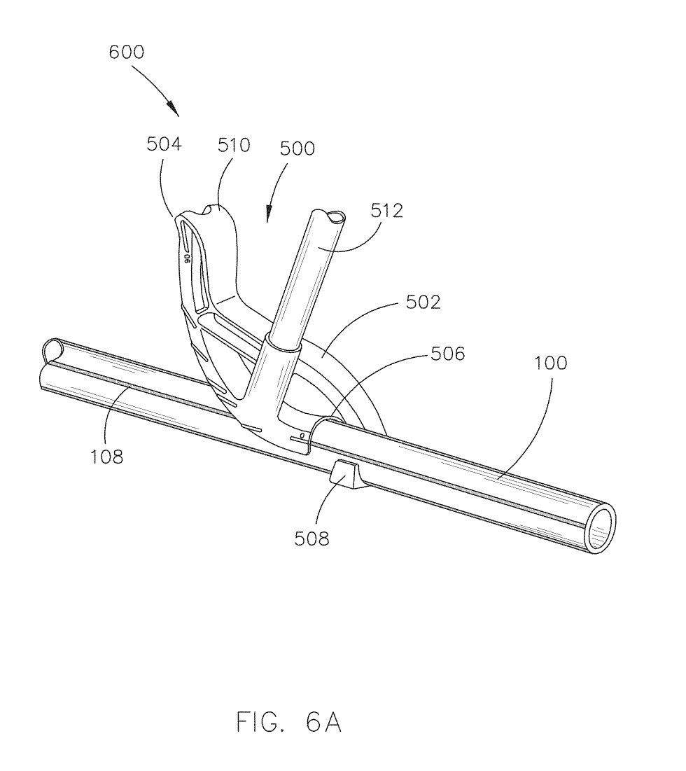

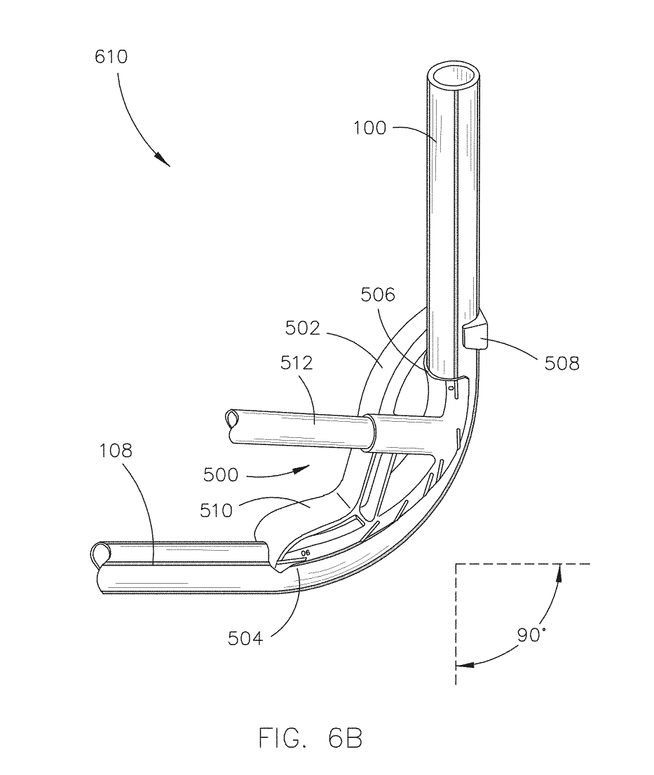

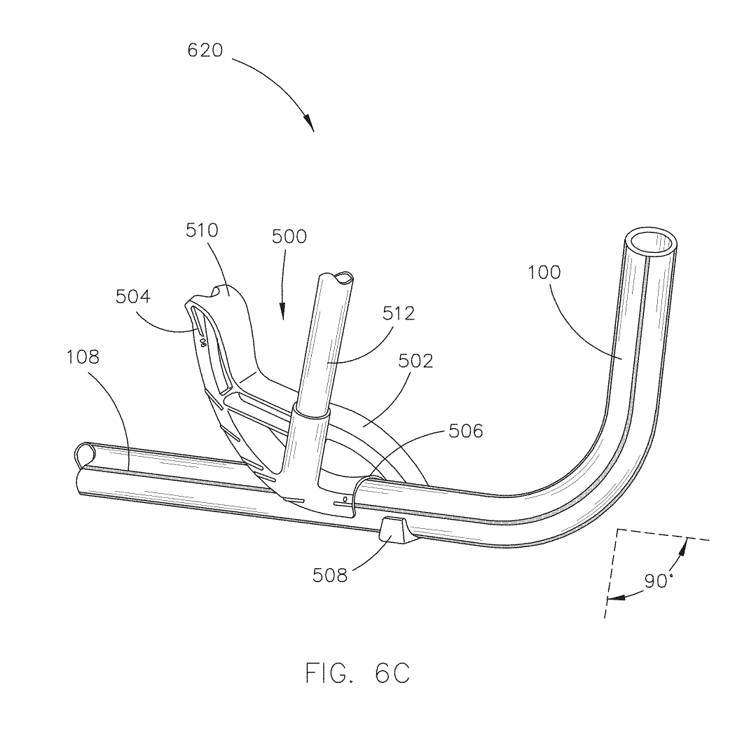

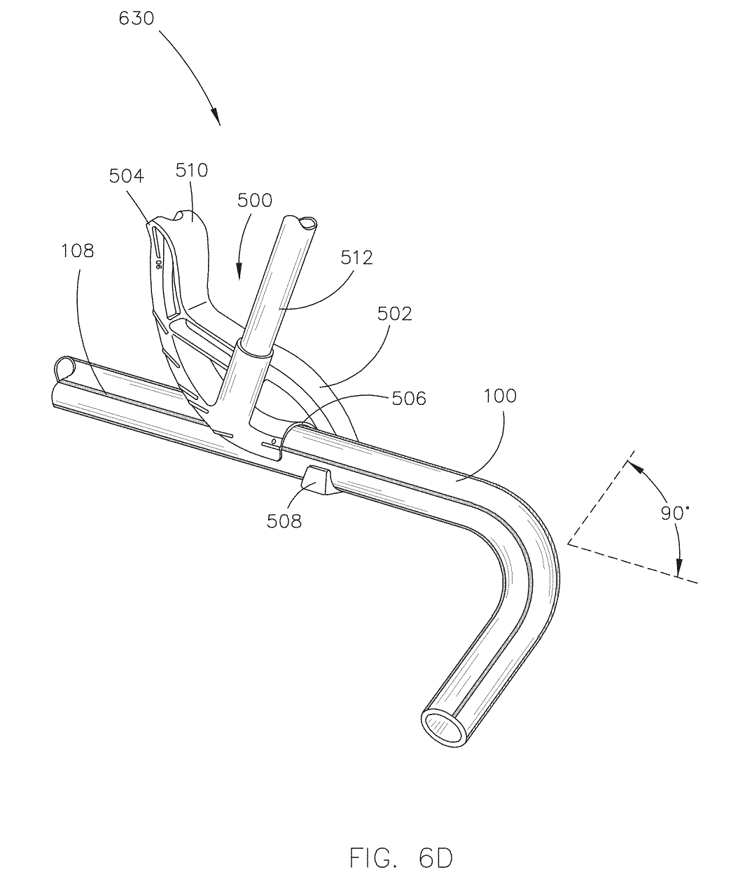

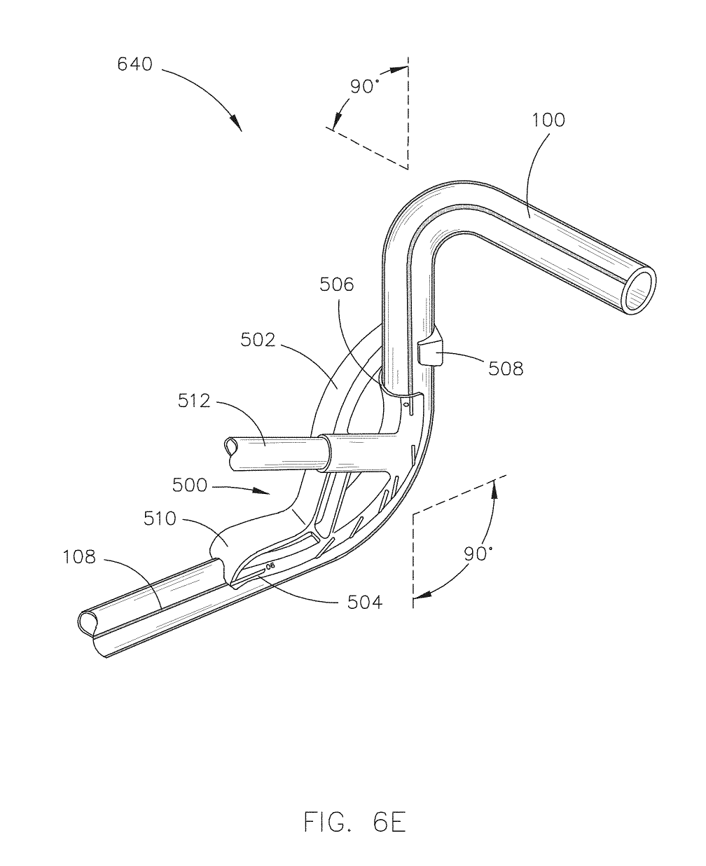

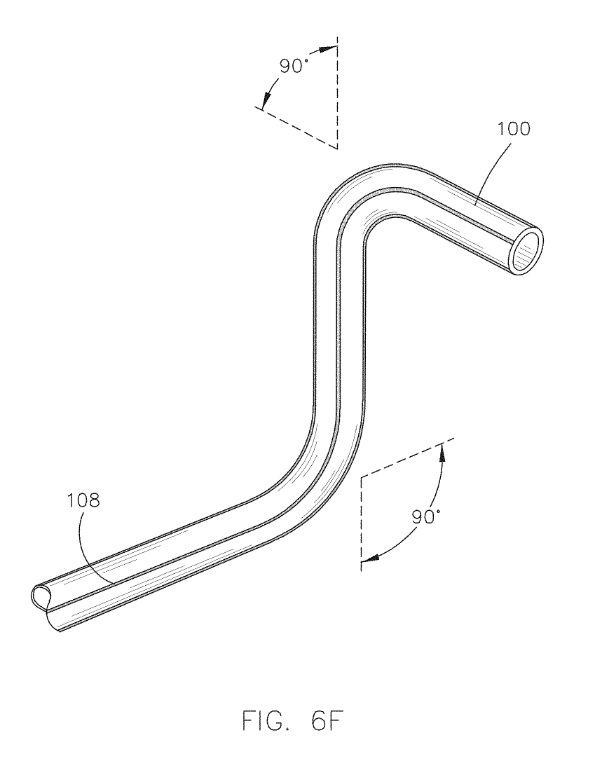

Referring now to FIGS. 6A-6F, select processes to bend electrical conduit 100 via the bending tool 500 is illustrated, in accordance with one or more embodiments of the present disclosure.

Complex precision bends including four-point saddles and rise/kick bends require utilizing select tools including offset levels, torpedo levels, and/or tape measures with the bending tool 500 to guide the shaping of the electrical conduit 100 during the precision bends.

For example, an offset level may be used for guidance when forming a four-point saddle. Forming a four-point saddle requires generating two offsets at measured distances apart. Following the first offset, the pipe is removed from the bending tool and is faced opposite end out for the second offset bend, which forms a saddle. The offset level needs to stay in place without bumping or jarring in order to keep perfect alignment until completion of the saddle.

By way of another example, a torpedo level may be used to for guidance when forming a rise/kick in the electrical conduit 100. Following the first 90-degree bend, forming the rise/kick requires laying the first bend on the floor and applying a force on the bending tool 500 a selected distance from the first bend while simultaneously holding while holding a torpedo level and/or a tape measure on the first bend to measure the amount of rise/kick. The number of parts that may shift (e.g. the torpedo level, the tape measure, the electrical conduit 100) that may shift while the second bend is formed may likely result in the electrical conduit 100 needing to be re-shaped.

With the one or more alignments marks 108, however, the torpedo level and/or the tape measure may not be required to form the complex precision bends, as illustrated via the set of processes in FIGS. 6A-6F to form a rise/kick in the electrical conduit 100 including four evenly-spaced alignment marks 108. It is noted herein the set of processes in FIGS. 6A-6F are not limited to the processes provided. For example, the set of processes in FIGS. 6A-6F may instead include more or fewer processes. By way of another example, the set of processes in FIGS. 6A-6F may perform the processes in an order other than provided. Therefore, the above description should not be interpreted as a limitation on the scope of the present disclosure, but merely an illustration.

In a process 600, as illustrated in FIG. 6A, the electrical conduit 100 is inserted into the conduit bend channel 506 and the hook 508 to a first distance along the length of the electrical conduit 100. Without leaving the control area of the bending tool 500, the operator may align a first alignment mark 108 (e.g., 0-degree alignment mark) with a first sight line 504 (e.g., the 0-degree sight line 504) of the bending shoe 502.

In a process 610, as illustrated in FIG. 6B, the electrical conduit 100 is bent to an angle of 90 degrees via a force exerted on the bending tool 500 (e.g., exerted on the handle 512, the foot pedal 510 of the bending shoe 502, or the like) by the operator, such that the first alignment mark 108 aligns with the a second sight line 504 (e.g., the 90-degree sight line 504) of the bending shoe 502.

In a process 620, as illustrated in FIG. 6C, the electrical conduit 100 is repositioned within the conduit bend channel 506 and the hook 508 to a second distance along the length of the electrical conduit 100. Without leaving the control area of the bending tool 500, the operator may align the first alignment mark 108 with the first sight line 504 (e.g., the 0-degree sight line 504) of the bending shoe 502.

In a process 630, as illustrated in FIG. 6D, the electrical conduit 100 is rotated. Without leaving the control area of the bending tool 500, the operator may rotate the electrical conduit 100 a total of 90 degrees to align a second alignment mark (e.g. the 90-degree or the 270-degree alignment mark) with the first sight line 504 (e.g., the 0-degree sight line 504) of the bending shoe 502.

In a process 640, as illustrated in FIG. 6E, the electrical conduit 100 is bent to an angle of 90 degrees via a force exerted on the bending tool 500 (e.g., exerted on the handle 512, the foot pedal 510 of the bending shoe 502, or the like) by the operator, such that the first alignment mark 108 aligns with the second sight line 504 (e.g., the 90-degree sight line 504) of the bending shoe 502. The rise/kick formed in the electrical conduit 100 is illustrated in FIG. 6 without the bending tool 500.

As illustrated by the set of processes in FIGS. 6A-6F, a torpedo level and/or a tape measure may not be necessary to form a rise/kick in the electrical conduit 100. It is noted herein that, with minor adjustments to the set of processes in FIGS. 6A-6F (e.g., bend, rotation angles), an offset level may not be necessary to form a saddle bend in the electrical conduit 100.

In this regard, the one or more alignment marks 108 provide an increased visual reference aid to an operator, as the operator is not required to spot check the one or more sight lines 504 against the bottom of the electrical conduit 100 and the one or more alignment marks 108 are visible to the operator while in the control area of the bending tool 100. As such, the one or more alignment marks 108 may be used as an alignment guide to prevent doglegs (e.g. skewed electrical conduit) from forming when bending the electrical conduit 100.

As illustrated in FIGS. 5A-6F, the electrical conduit 100 is shown with a symbolic break in its length, where the symbolic break indicates no particular length (e.g., indeterminate length) or diameter (e.g., indeterminate diameter) of the electrical conduit 100. It is noted herein that material that may be visible between the symbolic break has been removed for clarity. In addition, it is noted herein the appearance of any portion of the electrical conduit 100 between the symbolic break may not be considered an integral or required component of the electrical conduit 100. Further, the electrical conduit 100 is not limited to the scale as illustrated herein.

Although embodiments of the present disclosure illustrate the electrical conduit 100 as being bendable via a bending tool including a manually-operated bending shoe 500, it is noted herein the electrical conduit 100 may be bendable via any type of bending tool 500 (e.g., electrically-operated bending tool, electrically-assisted bending tool, hydraulically-operated bending tool hydraulically-assisted bending tool, mechanically-operated bending tool mechanically-assisted bending tool, or the like) known in the art. Therefore, the above description should not be interpreted as a limitation on the present disclosure but merely an illustration.

More generally although embodiments of the present disclosure are directed to electrical conduit, it is noted herein that electrical conduit is only one example of a structure to which the present invention may be applied and is not intended to be a limitation of the present disclosure. Therefore, the above description should not be interpreted as a limitation on the present disclosure but merely an illustration.

Advantages of the present disclosure include electrical conduit with one or more alignment marks. Advantages of the present disclosure also include bending the electrical conduit with a bending tool without the need for a second operator or special alignment tools. Advantages of the present disclosure also include utilizing the one or more alignment marks when bending the electrical conduit via the bending tool to prevent skewed and/or misshapen electrical conduit bends, or doglegs.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although an operator or operator is described herein as a single figure, those skilled in the art will appreciate that the operator may be representative of a human user, a robotic user (e.g., computational entity), and/or substantially any combination thereof (e.g., an operator may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although particular embodiments of this invention have been illustrated, it is apparent that various modifications and embodiments of the invention may be made by those skilled in the art without departing from the scope and spirit of the foregoing disclosure. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Accordingly, the scope of the invention should be limited only by the claims appended hereto.

What is claimed:

1. A bendable electrical conduit, comprising:
a body fabricated from a ductile material, the body comprising:
an exterior surface, a channel defined by an interior surface, and a wall of a select thickness separating the exterior surface and the interior surface; and
four alignment marks disposed on the exterior surface, wherein each set of adjacent alignment marks of the four alignment marks are separated by ninety degrees, wherein each alignment mark of the four alignment marks are comprised of at least one solid line,
wherein the body is configured to be insertable within a bending tool, wherein the body is configured to plastically deform following an application of a force to the exterior surface of the body via the bending tool, wherein plastic deformation of the body generates one or more bends along the length of the body.

2. A bendable electrical conduit, comprising:
a body fabricated from a ductile material, the body comprising:
an exterior surface, a channel defined by an interior surface, and a wall of a select thickness separating the exterior surface and the interior surface; and
at least two alignment marks disposed on the exterior surface, wherein a set of alignment marks of the at least two alignment marks are separated by a selected angle, wherein the at least two alignment marks are comprised of at least one line,
wherein the body is configured to be insertable within a bending tool, wherein the body is configured to plastically deform following an application of a force to the exterior surface of the body via the bending tool, wherein plastic deformation of the body generates one or more bends along the length of the body.

3. The bendable electrical conduit in claim 2, wherein the set of alignment marks includes adjacent alignment marks of the at least two alignment marks.

4. The bendable electrical conduit in claim 3, wherein the at least two alignment marks comprise two alignment marks, wherein the selected angle is 180 degrees.

5. The bendable electrical conduit in claim 3, wherein the at least two alignment marks comprise four alignment marks, wherein the selected angle is 90 degrees.

6. The bendable electrical conduit in claim 3, wherein the at least two alignment marks comprise eight alignment marks, wherein the selected angle is 45 degrees.

7. The bendable electrical conduit in claim 2, wherein the at least two alignment marks are comprised of at least one solid line.

8. The bendable electrical conduit in claim 2, wherein the at least two alignment marks are comprised of at least one patterned line.

9. The bendable electrical conduit in claim 2, wherein the at least two alignment marks are comprised of at least one un-patterned line.

10. The bendable electrical conduit in claim 2, further comprising at least one threaded section.

11. The bendable electrical conduit in claim 10, wherein the at least one threaded section is on a first portion of the exterior surface of the body, wherein the at least two alignment marks are disposed on an additional portion of the exterior surface of the body different from the first portion.

12. The bendable electrical conduit in claim 2, further comprising at least one integrated coupler formed during fabrication of the body.

13. The bendable electrical conduit in claim 12, wherein the integrated coupler forms a first portion of the exterior surface of the body, wherein the at least two alignment marks are disposed on an additional portion of the exterior surface of the body different from the first portion.

14. The bendable electrical conduit in claim 2, further comprising at least one coupler affixed to a portion of the exterior surface of the body.

15. The bendable electrical conduit in claim 14, wherein the coupler is affixed to a first portion of the exterior surface of the body, wherein the at least two alignment marks are disposed on an additional portion of the exterior surface of the body different from the first portion.

16. The bendable electrical conduit in claim 2, wherein the at least two alignment marks are disposed on the exterior surface of the body via one or more fabrication processes during fabrication of the body.

17. The bendable electrical conduit in claim 2, wherein the at least two alignment marks are disposed on the exterior surface of the body via at least one of one or more marking processes following fabrication of the body.

18. A method, comprising:
inserting a bendable electrical conduit into a bending tool including a bending shoe, wherein the bendable electrical conduit comprises:
a body fabricated from a ductile material, the body comprising:
an exterior surface, a channel defined by an interior surface, and a wall of a select thickness separating the exterior surface and the interior surface; and
at least two alignment marks disposed on the exterior surface, wherein a set of alignment marks of the at least two alignment marks are separated by a selected angle, wherein the at least two alignment marks are comprised of at least one line,
wherein the body is configured to plastically deform following an application of a force to the exterior surface of the body via the bending tool, wherein plastic deformation of the body generates one or more bends along the length of the body; and
bending the bendable electrical conduit via the bending tool until an alignment mark of the at least two alignment marks aligns with a sight line on the bending shoe of the bending tool.

19. The method in claim 18, further comprising:
bending the bendable electrical conduit via the bending tool until the alignment mark aligns with an additional sight line on the bending shoe of the bending tool.

20. The method in claim 18, further comprising:
rotating the bendable electrical conduit within the bending shoe of the bending tool after bending the bendable electrical conduit via the bending tool until the alignment mark of the at least two alignment marks aligns with the sight line on the bending shoe of the bending tool; and
bending the bendable electrical conduit via the bending tool until a second alignment mark aligns with the sight line on the bending shoe of the bending tool.
